(19) United States
(12) Patent Application Publication
(10) Pub. No.: US 2020/0222876 A1
(43) Pub. Date: Jul. 16, 2020

(54) FLUID-CONDUCTING DEVICE AND METHOD FOR MIXING FLUIDS

(71) Applicant: Linde Aktiengesellschaft, München (DE)

(72) Inventors: Manfred STEINBAUER, Raisting (DE); Hans-Joerg ZANDER, München (DE); Ole MUELLER-THORWART, Eichenau (DE); Konrad BRAUN, Lenggries (DE); Stefan GEWALD, München (DE)

(21) Appl. No.: 16/629,375

(22) PCT Filed: Jul. 6, 2018
(86) PCT No.: PCT/EP2018/025185

§ 371 Date: Jan. 8, 2020

(30) Foreign Application Priority Data
Jul. 10, 2017 (EP) 17020287.3

(51) Int. Cl. B01J 19/24; B01L 3/00; B01J 19/00; F28D 21/00

(52) U.S. Cl. CPC B01J 19/2415; B01L 3/502; F28D 2021/0052; F28D 21/0015; B01J 2219/00889; B01J 19/0053

(57) ABSTRACT

The invention relates to a fluid-conducting device (10) having a conduit block (12), within which there are formed multiple primary conduits (14) which extend in a primary conduit direction (100) and which are designed to conduct a primary fluid. The fluid-conducting device furthermore has at least one secondary conduit (16), which extends at least partially in a secondary conduit direction (102) extending at least partially perpendicular to the primary conduit direction (100) and which is designed to conduct or to receive a secondary fluid. Here, the at least one secondary conduit (16) opens into at least one of the primary conduits (14) in order to allow the secondary fluid to flow into the at least one primary conduit (14) via the secondary conduit (16); wherein the fluid-conducting device (10) is formed at least partially by an additive manufacturing process, wherein the multiple primary conduits (14) extend parallel to one another exclusively in a primary conduit direction, wherein the fluid-conducting device (10) is configured such that it can be arranged between two tubing elements and can be fastened thereto such that a primary fluid stream through the first tubing element in the primary conduit direction passes to the fluid-conducting device (10) such that the primary fluid stream is able to penetrate into the primary conduits (14) in the conduit block (12), and such that a fluid flowing out of the fluid-conducting device in the primary conduit direction is able to flow out of the fluid-conducting device into the second tubing element. The invention also relates to a tube plate, to a tube reactor, and to a static mixer (28), which have a fluid-conducting device (10) according to the invention. The invention moreover relates to a method for mixing fluids, and to a method for producing a fluid-conducting device and/or a tube plate.

The invention relates to a method for mixing a secondary fluid into a primary fluid, and to a method for monitoring a tube flow, and to a fluid-conducting device, in particular for a tube plate of a heat exchanger and/or for a tube reactor and/or for a static mixer.

### PRIOR ART

Many installations and processes require controlled feeding-in of one of more fluids for an efficient operation or procedure. If the feeding-in of multiple fluids is required, a distribution of multiple fluids or phases that is as controlled as possible, such as for example an equal distribution thereof, may in particular be required here, in order for example to obtain a homogeneous mixture or distribution of the fluids in the flow of the fed-in fluids.

In particular in the case of delicate tubing systems, as are often used for example in tube plates of heat exchangers, such as for example in a TEMA heat exchanger and/or in helically coiled heat exchangers, feeding-in of multiple fluids such that these are mixed as homogeneously as possible is often not technically realizable, or is technically realizable only to an insufficient extent or with a very high technical outlay.

However, technical solutions which are known for example from other technical fields, such as for example the use of a two-phase bar in plate-type heat exchangers, are, for many delicate tubing systems, not suitable and therefore not usable and/or do not allow sufficient mixing of the fluids.

Conventionally, therefore, it is often the case that apparatuses and/or delicate tubing systems with a two-phase entry, that is to say with a feed for two fluids of different phases, are overdimensioned in order to compensate at least partially for demixing. Alternatively or additionally, the processes have to be reconfigured, typically with acceptance of a loss of efficiency, if the undesired demixing would have a considerably negative influence on the process, such as can be the case in autorefrigeration processes for example.

If, for example, a fluid is intended to be condensed in a heat exchanger and enters the heat exchanger already in a two-phase state, demixing of the two phases can occur in a tubing before the entry into the heat exchanger, that is to say upstream of the entry into the tube plate. This can have the result that, downstream of the tube plate, some heat exchange tubes are completely or largely filled with liquid and other heat exchange tubes are filled completely or largely with gas. The tubes already filled with liquid cannot bring about any condensation and thus do not contribute to the condensation of the fluid. In this case, the entire heat removal necessary for the condensation consequently has to be realized via the tubes which are completely or largely gas-filled at the beginning. In order to compensate for the heating area which—due to the tubes filled with liquid—is lost, conventionally the heat exchangers are often equipped with a larger number of tubes than would actually be necessary, in order still to have a sufficient heating area available in the non-dipped region, that is to say in the tubes which are not filled with liquid. Consequently, to compensate for demixing of a multi-phase fluid in the heat exchanger, conventionally overdimensioning is often required.

Furthermore, typically it is often the case that one of two fluids or phases is conducted around the delicate tubing system by means of a bypass, and subsequently, that is to say beyond the delicate tubing system, fed to the main stream, which can likewise result in a loss of efficiency and moreover increases the production costs and/or the complexity of the installation.

Similar technical difficulties arise in the case of monitoring of a process step or of a flow in a delicate tubing system, such as for example a tube plate. For example, for local control or regulation of a process step in a heat exchanger and/or in a tube reactor, spatially controlled feeding-in of different fluids may be required, which, owing to the increased difficulty of access to the delicate tubing system and/or of the often high loads to which sensors to be attached are subjected, is often not realizable or is realizable only with high technical outlay. In particular, it may be required or desirable, individual tube fractions, that is to say a subset of all the tubes, of an apparatus and/or of a delicate tubing system and/or of a heat exchanger, to monitor the flow in an individual flow tube, in order to control and/or to regulate the flow in individual fractions of the delicate tubing system.

The invention is therefore based on the object of providing a fluid-conducting device and a method for mixing a secondary fluid into a primary fluid, which make possible reliable feeding-in of fluids and, for their realization, require a low technical outlay.

The object is achieved by a fluid-conducting device, a tube plate, a tube reactor, a static mixer and a method for mixing a secondary fluid into a primary fluid having the features of the respective independent claims. Preferred embodiments are the subject matter of the dependent claims and of the description that follows.

In a first aspect, the invention relates to a fluid-conducting device having a conduit block, within which there are formed multiple primary conduits which extend in a primary conduit direction and which are designed to conduct a primary fluid. The fluid-conducting device furthermore has at least one secondary conduit, which extends at least partially in a secondary conduit direction extending at least partially perpendicular to the primary conduit direction and which is designed to conduct a secondary fluid.

Here, the at least one secondary conduit opens into at least one of the primary conduits in order to allow the secondary fluid to flow into the at least one primary conduit via the secondary conduit. The fluid-conducting device is formed at least partially by an additive manufacturing process, wherein the multiple primary conduits extend parallel to one another exclusively in a primary conduit direction, wherein the fluid-conducting device is configured such that it can be arranged between two tubing elements and can be fastened thereto such that a primary fluid stream through the first tubing element in the primary conduit direction passes to the fluid-conducting device such that the primary fluid stream is able to penetrate into the primary conduits in the conduit block, and such that a fluid flowing out of the fluid-conducting device in the primary conduit direction is able to flow out of the fluid-conducting device into the second tubing element.

In a further aspect, the invention relates to a tube plate for a heat exchanger, wherein the tube plate has a fluid-conducting device according to the invention, and wherein the tube plate is designed such that tubings are connectable to the primary conduits.

In a further aspect, the invention relates to a tube reactor which has a fluid-conducting device according to the invention, wherein at least one reactor tube is connected to the primary conduits so as to extend in the primary conduit direction.

In a further aspect, the invention relates to a static mixer which has a fluid-conducting device according to the invention, wherein at least one tubing element, such as for example a main flow tube, is connected to the primary conduits so as to extend in the primary conduit direction.

In a further aspect, the invention relates to a method for mixing a secondary fluid into a primary fluid, comprising providing a fluid-conducting device produced at least partially by an additive manufacturing process and having a conduit block, within which there are formed multiple primary conduits which extend in a primary conduit direction and which are designed to conduct a primary fluid; having at least one secondary conduit, which extends at least partially in a secondary conduit direction extending at least partially perpendicular to the primary conduit direction and which is designed to conduct a secondary fluid; wherein the at least one secondary conduit opens into at least one of the primary conduits in order to allow the secondary fluid to flow into the at least one primary conduit via the secondary conduit, wherein the multiple primary conduits extend parallel to one another exclusively in a primary conduit direction, wherein the fluid-conducting device is configured such that it can be arranged between two tubing elements and can be fastened thereto such that a primary fluid stream through the first tubing element in the primary conduit direction passes to the fluid-conducting device such that the primary fluid stream is able to penetrate into the primary conduits in the conduit block, and such that a fluid flowing out of the fluid-conducting device in the primary conduit direction is able to flow out of the fluid-conducting device into the second tubing element. The method furthermore comprises feeding the primary fluid into the primary conduit such that the primary fluid flows through the primary conduits, and feeding the secondary fluid into the primary conduits via the at least one secondary conduit such that mixing of the secondary fluid with the primary fluid is realized in the primary conduits.

The conduit block within which there are formed multiple primary conduits is preferably formed integrally. The primary conduits may, for example, be formed as cutouts in the conduit block and/or be arranged and/or fastened, so as to extend in the conduit block, as primary conduit elements. For example, the conduit block can preferably be produced by means of an additive manufacturing process printing such that the primary conduits are formed already at the same time as the completion of the conduit block.

The primary fluid and/or the secondary fluid comprise in each case one fluid, which may preferably be present in gas phase and/or in liquid phase and/or as a particulate fluid, such as for example as a particle stream. Preferably, the primary fluid is a fluid which is to be conducted by means of the fluid-conducting device and to which at least one secondary fluid is intended to be admixed. Preferably, the diameters of the primary conduits are larger than the diameters of the secondary conduits. Preferably, the primary conduits make possible a greater throughflow of fluid than the secondary conduits. The fact that the at least one secondary conduit opens into at least one of the primary conduits means here that a fluid flowing through the at least one secondary conduit can flow into the at least one primary conduit in which the correspondingly formed and arranged secondary conduit opens.

The additive manufacturing process may in this case preferably be a 3D printing process, and for example SLM (selective laser melting) and/or SLS (selective laser sintering).

The invention offers the advantage that the multiple primary conduits may be used for allowing a primary fluid to flow through, while a secondary fluid may be added or injected by means of the at least one secondary conduit. In particular, the primary fluid flows through the multiple primary conduits, and for this reason a plurality of partial streams of the primary fluid are already present within the conduit block or within the fluid-conducting device, into which partial streams the secondary fluid can then be injected. The fact that the secondary fluid can be injected into the multiple partial streams of the primary fluid means that a more homogeneous distribution of the secondary fluid into the primary fluid can be achieved, since the secondary fluid can preferably be distributed uniformly and/or according to a desired spatial distribution among the multiple primary conduits or partial streams of the primary fluid. This offers better mixing than is achievable for example conventionally when, in a single main flow of the primary fluid, the secondary fluid is injected laterally at one of more positions, since, in the conventional case, the diameter of the main flow typically has a significantly larger diameter than an individual partial stream.

The invention furthermore offers the advantage that the multiple primary conduits or partial streams of the primary fluid are made accessible by means of the at least one secondary conduit, and can be reached in this way according to the corresponding needs in relation to fed-in secondary fluid. In this way, a main stream, divided among the multiple primary conduits, of the primary fluid, that is to say a primary fluid stream, can be spatially addressed in order for the secondary fluid to flow, or to be injected, into particular partial streams.

The invention furthermore offers the advantage that the fluid-conducting device can be produced in a compact and preferably integral design. This offers the advantage that the primary conduits or partial streams of the primary fluid are accessible in an extremely small space without a high degree of space requirement and/or technically demanding and/or costly structures being required for this purpose. In particular, by the at least partial production of the fluid-conducting device by means of an additive manufacturing process or 3D printing, it is possible for the fluid-conducting component and in particular the conduit block and also the at least one secondary conduit to be produced as an integral component without technically demanding rework being absolutely necessary at positions which are accessible only with difficulty. Furthermore, the fluid-conducting device according to the invention may, if appropriate, be produced with structures which are not able to be produced by different production processes.

Preferably, the multiple primary conduits extend substantially parallel to one another. This offers the advantage that a large number of primary conduits can be accommodated or arranged in the conduit block and/or spacings between the primary conduits in the conduit block can be minimized. In this way, a total cross-sectional area or a total throughflow quantity or rate can be increased or maximized by way of the totality of all the primary conduits formed in the conduit block.

Preferably, the at least one secondary conduit is arranged so as to extend substantially in at least one secondary conduit plane, wherein the at least one secondary conduit plane preferably extends substantially perpendicular to the primary conduit direction. “Substantially perpendicular to the primary conduit direction” means here that slight deviations, such as for example due to production tolerances, are possible, wherein this should still be considered as being a perpendicular extension. In other words, the at least one secondary conduit extends at least partially, preferably however mostly or completely, perpendicular to the primary conduits. This offers the possibility of configuring the fluid-conducting device in a compact and/or space-saving manner. This also offers the possibility that, by means of the at least one secondary conduit, the secondary fluid can be fed into the respective primary conduits at in each case the same position along the primary conduit direction. Preferably, the fluid-conducting device has multiple secondary conduits which are arranged so as to lie in the same plane perpendicular to the primary conduit direction and/or are arranged so as to lie in multiple planes perpendicular to the primary conduit direction. This offers the advantage that the same and/or different secondary fluids can be fed in at the same and/or different positions along the primary conduit direction.

Preferably, the at least one secondary conduit is formed at least partially within the conduit block. Particularly preferably, the conduit block can be produced already directly with the at least one secondary conduit formed therein. If the fluid-conducting device has multiple secondary conduits, preferably some but particularly preferably all of these can extend within the conduit block. This has the advantage that the fluid-conducting device can be of particular compact construction and/or that an arrangement of the primary conduits and the secondary conduits that is particularly advantageous for the mixing of the primary fluid with the secondary fluid can be achieved.

Preferably, the at least one secondary conduit is formed at least partially as a secondary conduit structure. The secondary conduit structure may in this case be arranged or formed within the conduit block and/or be formed at least partially outside the conduit block and preferably be fastened to the conduit block.

If the at least one secondary conduit and/or the secondary conduit structure is formed and/or fastened at least partially outside the conduit block, this may offer the advantage that the fluid-conducting device can be produced in a particularly simple manner. Moreover, this may offer the advantage that the at least one secondary conduit and/or the secondary conduit structure can be attached and/or mounted to an already prefabricated conduit block and/or an already prefabricated fluid-conducting element at a later stage, for example by means of an additive manufacturing process or 3D printing. Consequently, it is possible for example for a fluid-conducting element which is not provided with at least one integrated secondary conduit to be retrofitted with at least one secondary conduit and/or a secondary conduit structure at a later stage.

Alternatively or additionally, it is preferably possible for the secondary conduit structure to be formed integrally with the conduit block and/or to preferably be produced at least partially by an additive manufacturing process or 3D printing. This offers the advantage that the conduit block can be produced with the primary conduits and the secondary conduit structure preferably in one working step by means of 3D printing. This in turn offers the advantage that, for example, the conduit block and in particular the secondary conduits or the secondary conduit structure are able to be produced as particularly complex structures, which for example would not be realizable by other production processes. This furthermore offers the advantage that the conduit block, after its production, does not necessarily need to be reworked in complex working steps in order to generate the secondary conduit structure.

Preferably, the multiple primary conduits each have an inlet opening, wherein the inlet openings of the multiple primary conduits are preferably arranged so as to lie in an inlet plane, and wherein the conduit block preferably terminates flush with the inlet openings. Particularly preferably, the conduit block has a planar surface, in which the inlet openings of the multiple primary conduits are formed as cutouts and from which the primary conduits extend away from the inlet plane in the primary conduit direction. This offers the advantage that the primary fluid, which is intended to be fed into the primary conduits, for example by means of a large flow tube, can be conducted to the conduit block, or to the inlet plane, such that, there, the primary fluid is conducted by means of the conduit block or the fluid-conducting device into the inlet openings of the multiple primary conduits.

Preferably, the fluid-conducting device is formed integrally. In other words, the conduit block, the primary conduits, and the at least one secondary conduit or the secondary conduit structure are preferably formed integrally, particularly preferably at least partially by means of an additive manufacturing process. This offers the advantage that the fluid-conducting device can be produced in a particularly compact manner and/or with little effort in terms of labor.

Preferably, the at least one secondary conduit opens into a plurality of primary conduits of the multiple primary conduits. This offers the advantage that, by means of the at least one secondary conduit, a plurality of primary conduits can be provided with a supply, or is accessible, via corresponding mouths or branches or simply via outlet openings. Consequently, the number of secondary conduits can be reduced and a large number of primary conduits can still be provided with secondary fluid.

Particularly preferably, at least one secondary conduit opens into each of the primary conduits. This offers the advantage that a secondary fluid is able to be fed into each of the primary conduits.

Preferably, the feeding-in of the secondary fluid can be realized via one or more secondary conduits of the multiple secondary conduits independently of the other secondary conduits of the multiple secondary conduits. This offers the advantage that the feeding-in or injection of the secondary fluid does not necessarily need to be realized in a uniform or similar manner via all the secondary conduits, but that secondary fluid can be fed in via one or some of the secondary conduits in a targeted manner for example. This moreover offers the advantage that, preferably, the secondary fluid can be fed in a targeted manner into only some of the primary conduits.

In particular in the case of use in a tube reactor, this may for example offer the advantage that, at different positions of the cross section of the tube reactor, the reaction process can be controlled or regulated in a targeted manner by way of targeted feeding-in of the secondary fluid.

Preferably, a tube plate according to the invention for a heat exchanger can be produced at least partially by an additive manufacturing process. This offers the advantage that the tube plate can be produced in a particularly compact manner, and/or with a complex structure which would not be realizable by means of other production processes.

Further advantages and configurations of the invention will emerge from the description and the appended drawings.

It goes without saying that the features mentioned above and the features yet to be discussed below are able to be used not only in the respectively specified combination but also in other combinations or individually without departing from the scope of the present invention.

The invention is schematically illustrated in the drawings on the basis of exemplary embodiments and is described below with reference to the drawings.

### DESCRIPTION OF THE FIGURES

FIG. 1A shows, in a schematic illustration, a fluid-conducting device according to a preferred embodiment in plan view.

FIG. 1B shows, in a schematic illustration, a fluid-conducting device according to a further preferred embodiment in plan view.

FIG. 2A shows, in a schematic illustration, a detail of a fluid-conducting device according to a second preferred embodiment.

FIG. 2B shows, in a schematic illustration, a detail of a fluid-conducting device according to a third preferred embodiment.

FIG. 2C shows, in a schematic illustration, a detail of a fluid-conducting device which is not part of the invention.

FIG. 3 shows, in a schematic illustration, a static mixer according to a first preferred embodiment, which has a fluid-conducting device.

### DETAILED DESCRIPTION OF THE DRAWINGS

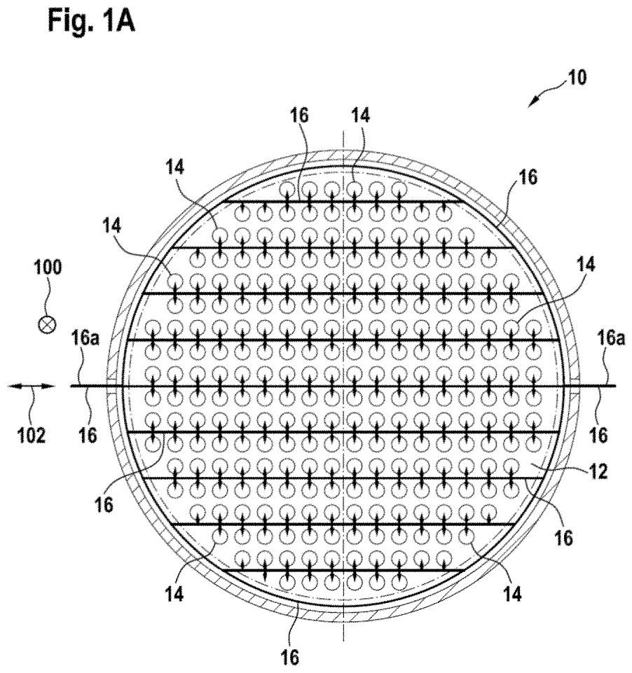

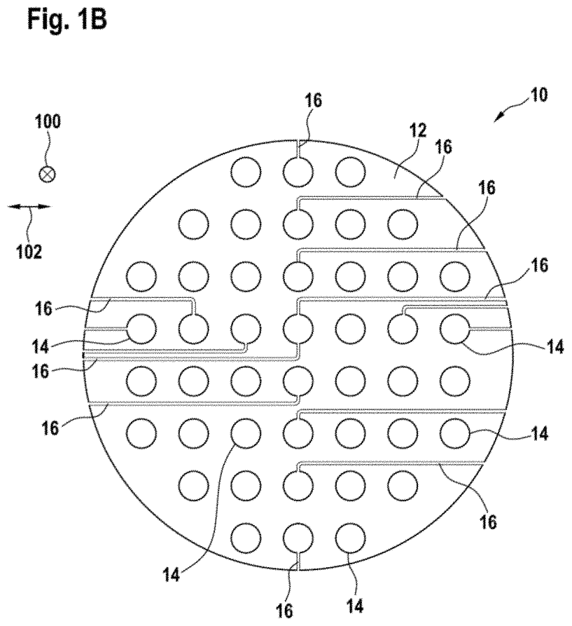

FIG. 1A shows, in a schematic illustration, a fluid-conducting device 10 according to a preferred embodiment in plan view. The fluid-conducting device 10 has a conduit block 12 in which multiple primary conduits 14 are formed. Although not all the primary conduits 14, represented as circular openings, are provided with reference signs, it is nevertheless the case that all the circular openings of the same type each represent a primary conduit 14. The primary conduits 14 extend in the primary conduit direction 100, which extends into the plane of the drawing in the illustration shown.

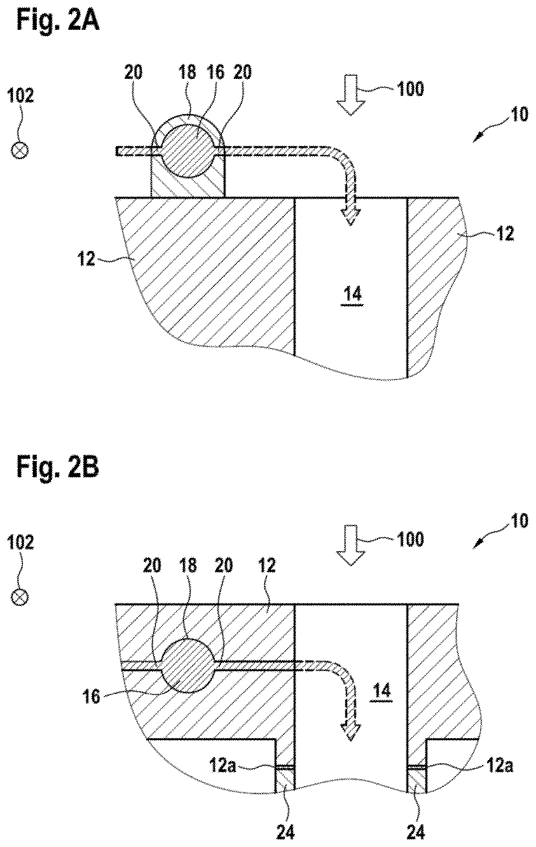

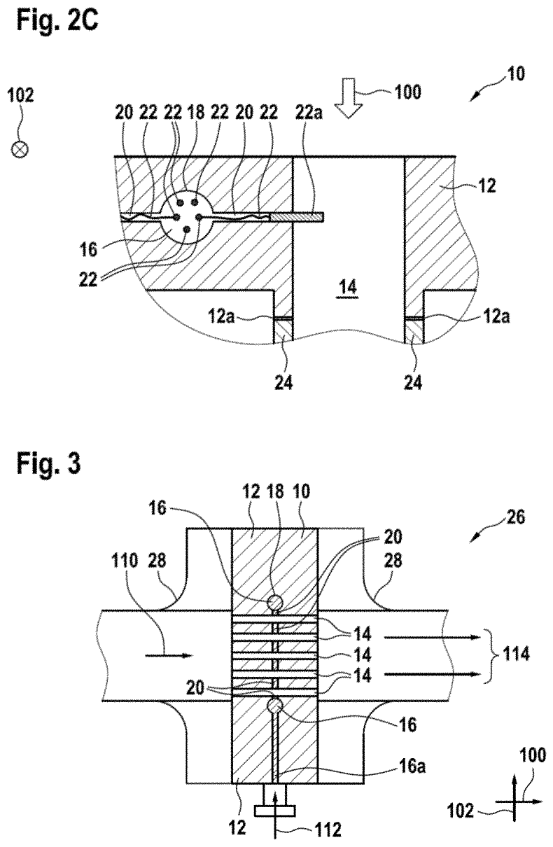

Multiple secondary conduits 16 extend in a plane perpendicular to the primary conduit direction 100 and open into the primary conduits 14. It is possible via the secondary conduits 16 for the secondary fluid to be injected into the primary conduits 14 in the secondary conduit direction 102 via the feed conduits 16a. Alternatively, and not constituting part of the invention, or additionally, it is possible via the secondary conduits 16 for one or more sensor elements 22 (see FIG. 2C) to be introduced for the purpose for example of coming into contact with a stream of primary fluid in the primary conduits 14.

Here, the flow direction of the secondary fluid in the secondary conduits 16 is intended to be applicable to the secondary conduit direction 102, although, in mathematical terms, said flow direction does not strictly extend in a direction.

According to the shown preferred embodiment of the fluid-conducting device 10, one secondary conduit 16 opens into each primary conduit 14, while each secondary conduit 16 opens into a plurality of primary conduits 14. Here, the secondary fluid can be fed in via one feed conduit 16a, or from both sides in temporal succession, or simultaneously, via both feed conduits 16a. The simultaneous feeding-in via both feed conduits 16a preferably ensures a relatively uniform feeding of the secondary fluid into each primary conduit, since all the flow paths of the secondary fluid thereby have similar lengths and thus similar pressure losses. It also offers the advantage that the secondary fluid can be fed in quicker, or with a higher flow rate, than if the secondary fluid is fed in only via one of the feed conduits 16a.

For example, the fluid-conducting device 10 may be formed in a tube plate and/or as a tube plate for a heat exchanger. Alternatively, the fluid-conducting device 10 may be used in a tube reactor, for example in a tube bundle reactor (not shown). A tube reactor can have multiple tubes, which preferably extend in a parallel manner and through which a process medium flows. For example, the process medium may be present as the primary fluid and conducted into the individual tubes of the tube reactor by means of the fluid-conducting device 10 or the primary conduits 14. The desired chemical conversions can then take place in the tubes. Heat emissions are often associated with chemical reactions. In order to operate the tube reactor in a reliable temperature range, the heat released in exothermic reactions must in some cases be removed and/or the heat to be absorbed in endothermic reactions must be provided. This may be realized for example by means of an exchange of heat via the tube walls. Furthermore, the tubes may frequently be filled with a catalyst bed. However, there are also non-catalytic reactions able to be carried out for which the tubes may be filled with inert beds and/or may remain empty.

If it is expected that the reaction will start immediately after the reaction partners are brought together, for example after the primary fluid is brought together with the secondary fluid, this may necessitate further safety measures. If, for example, the reaction occurs prior to the entry of the primary fluid into the reactor tube, no heat removal would be possible first of all, with the result that the reaction could overheat and/or progress in an uncontrolled manner. Also, undesirable secondary reactions as a result of non-catalytic reaction could be a problem here. These difficulties are avoided through the use of a tube reactor having a fluid-conducting device 10 according to the preferred embodiment, since the reaction partners are mixed at the latest possible time, specifically are not mixed until they are in the primary conduits 14 or in the conduit block 12. In this way, a tube reactor according to the invention according to the preferred embodiment permits very late mixing of the reaction partners, that is to say of the primary fluid with the secondary fluid, directly upon entry into the into the primary conduits 14 or into the reactor tubes.

FIG. 1B shows, in a schematic illustration, a fluid-conducting device 10 according to a further preferred embodiment in plan view, in particular for a tube plate. Here, there are formed multiple secondary conduits 16 which do not extend completely parallel to one another. Here, each of the secondary conduits 16 opens into only one primary conduit 14, wherein some of the primary conduits 14 may also be connected to multiple secondary conduits 16. Via the secondary conduits 16, it is possible for example for sensor elements 22 (not shown) to be brought to the respective primary conduits 14 from outside the fluid-conducting device 10 or the conduit block 12 or the tube plate. In particular, the secondary conduits 16 may be integrated into the conduit block. This shows that it is advantageously possible for such a tube plate or such a fluid-conducting element to be produced by means of an additive manufacturing process or 3D printing, since a realization of such structures by way of other production techniques would not be realizable or would be realizable only with a very high technical outlay.

FIG. 2A shows, in a schematic illustration, a detail of a fluid-conducting device 10 according to a second preferred embodiment. Here, a primary conduit 14 is in particular illustrated in the conduit block 12, which primary conduit is designed to conduct a primary fluid in the primary conduit direction 100. Furthermore, the fluid-conducting device 10 shows a secondary conduit 16, which is formed as a or in a secondary conduit structure 18, wherein the secondary conduit structure 18 is arranged on the conduit block 12 and is fastened to the conduit block 12. For example, the secondary conduit structure 18 may, by means of an additive manufacturing process or 3D printing, be printed or be formed on the conduit block 12.

Within the secondary conduit, the secondary fluid can flow in the secondary conduit direction 102, wherein a mouth of the secondary conduit 16 into the primary conduit 14 is formed such that the secondary conduit structure 18 has, at corresponding positions, outlet openings 20 from which the secondary fluid can exit the secondary conduit structure 18 in order to flow into the corresponding primary conduit 14. The flow of the secondary fluid from the outlet openings 20 into the respective primary conduits 14 may in this case be supported by a flow or a stream of the primary fluid in the primary conduit direction 14. In other words, a stream of the primary fluid in the primary conduit direction can help the secondary fluid exiting the outlet openings 20 of the secondary structure 18 to be drawn along into the primary conduits or entrained. For example, the secondary conduit structure 18 may have two opposite outlet openings 20 at the same height or at the same position along the secondary conduit direction 102, in order for example to feed secondary fluid into two adjacent primary conduits 14 (merely one primary conduit 14 being illustrated). It is alternatively possible for provision to be made of a branch from the secondary conduit 16, which branch directs the secondary fluid in the desired direction to the mouth of the primary conduit 14. The fluid-conducting device 10 may be used for example as a tube plate and/or in a tube plate for a heat exchanger.

FIG. 2B shows, in a schematic illustration, a detail of a fluid-conducting device 10 according to a third preferred embodiment. This differs in particular from the second preferred embodiment in that the secondary conduit structure 18 is not arranged outside the conduit block 12 and is not fastened to the conduit block 12, but rather is formed within the conduit block 12. For example, the conduit block 12 may be formed so as to already have the integrated secondary conduit structure 18. Here, both the secondary conduit 16 and the outlet openings 20 extend within the conduit block, with the result that the conduit block 12 comprises the primary conduits 14 and the secondary conduits 16 and is formed as an integral component.

Furthermore, in the embodiment shown of the fluid-conducting device 10, connecting elements 12a are illustrated at the conduit block 12, by means of which it is possible for example for conduit tubes to be connected to the primary conduits 14. For example, it is possible via the connecting elements 12a for tubings 24, for example of a heat exchanger, to be connected to the conduit block 12 if the fluid-conducting device is used in a or as a tube plate for a heat exchanger. The connecting elements 12a may in this case also be formed integrally with the fluid-conducting device 10 or with the conduit block 12 and produced for example by means of an additive manufacturing process or 3D printing.

FIG. 2C shows, in a schematic illustration, a detail of a fluid-conducting device 10 which is not part of the invention. In particular, the illustrated fluid-conducting device 10 differs however from the third preferred embodiment in that the secondary conduit structure 18 or the secondary conduits 16 are not used for conducting a secondary fluid, but rather are provided with sensor elements 22. Here, the sensor elements 22 are preferably formed as cables and/or wires and/or fibers, which are able to be led through the secondary conduits 16. Here, multiple sensor elements 22 extend in the secondary conduit 16. According to the illustrated embodiment, five sensor elements 22 extend in the secondary conduit 16. The sensor elements 22 are then able to be led via the outlet openings 20 to the respective primary conduits 14 such that a sensor head 22a of the respective sensor element 22 projects into the respective primary conduit 14 or is connected to the latter in a fluid-tight manner. In this way, it is possible by means of the sensor element 22 for a parameter of the primary fluid flowing through the respective primary conduit 14 to be determined or measured, the sensor elements 22, for example, being able to be formed as pressure sensors and/or temperature sensors or comprise such sensors. This makes it possible for a pressure and/or a temperature of the throughflowing primary fluid to be able to be measured in the primary conduits 14. Alternatively or additionally, the secondary conduits 16 or the secondary conduit structure 18 may also be printed or formed on the conduit block 12 according to the embodiment shown in FIG. 2A.

FIG. 3 shows, in a schematic illustration, a static mixer 26 which has a fluid-conducting device 10. Here, the static mixer is arranged between two tubing elements 28 and is fastened thereto such that a primary fluid stream 110 through the first tubing element 28 passes to the fluid-conducting device 10 such that the primary fluid stream 110 is able to penetrate into the primary conduits 14 in the conduit block 12 or is divided among said primary conduits. Formed here in the conduit block 12 is a secondary conduit structure 18 in which, via the feed conduit 16a, a secondary fluid stream 112 is fed into the secondary conduits 16 or the secondary conduit structure 18 such that, via the connecting elements 20, the secondary fluid can open into the primary conduits 14 in order, there, to mix with the primary fluid. The fluid flowing out of the fluid-conducting device 10 in the primary conduit direction 100 thus accordingly comprises a mixture of primary fluid and secondary fluid, or a mixed fluid stream 114, which comprises the primary fluid and the secondary fluid.

The static mixer 26 thus serves for mixing the primary fluid with the secondary fluid, wherein preferably the mixing is brought about solely by the flow movement of the primary fluid stream 110 and the secondary fluid stream 112. As a result of the primary conduits 14, the primary fluid stream 110 is divided, mixed with the secondary fluid stream 112 and then combined again into a mixed fluid stream 114.

The use of the fluid-conducting device 10 makes it possible in this way for very good mixing of the primary fluid with secondary fluid to be achieved, since the combining of the primary fluid stream 110 and the secondary fluid stream 112 is realized via a multiplicity of mouths or outlet openings 20 in the primary conduits 14, which are preferably distributed uniformly over the entire cross section of the flow tube 28. Moreover, according to the embodiment shown, preferably by way of the narrowing of the flow cross section from the tubing 28 to the primary conduits 14, an increased speed and/or turbulence of the primary fluid stream 110 is obtained, which contributes to the mixing. Furthermore, as a result of such a static mixer 26, preferably with the exiting of the mixed fluid stream 114 from the primary conduits 14 into the tubing 28 in the primary conduit direction 100, considerable swirling is obtained, which in turn has a positive effect on the mixing.

Furthermore, a static mixer 26 according to the preferred embodiment offers the advantage that at least the primary conduits 14 are able to be cleaned mechanically, and are thus also able to be used for fluids with a high fouling value without the risk of permanent attachment of impurities and/or blockage of the primary conduits 14.

### REFERENCE SIGNS

10 Fluid-conducting device
12 Conduit block
12a Connecting element
14 Primary conduit
16 Secondary conduit
16a Feed conduit
18 Secondary conduit structure
20 Outlet opening
22 Sensor element
22a Sensor head
24 Tubing
26 Static mixer
28 Tubing element
100 Primary conduit direction
102 Secondary conduit direction
110 Primary fluid stream
112 Secondary fluid stream
114 Mixed fluid stream

1. A fluid-conducting device (10) having:
a conduit block (12), within which there are formed multiple primary conduits (14) which extend in a primary conduit direction (100) and which are designed to conduct a primary fluid;
at least one secondary conduit (16), which extends at least partially in a secondary conduit direction (102) extending at least partially perpendicular to the primary conduit direction (100) and which is designed to conduct a secondary fluid;
wherein the at least one secondary conduit (16) opens into at least one of the primary conduits (14) in order to allow the secondary fluid to flow into the at least one primary conduit (14) via the secondary conduit (16); and
wherein the fluid-conducting device (10) is formed at least partially by an additive manufacturing process,
wherein the multiple primary conduits (14) extend parallel to one another exclusively in a primary conduit direction, wherein the fluid-conducting device (10) is configured such that it can be arranged between two tubing elements and can be fastened thereto such that a primary fluid stream through the first tubing element in the primary conduit direction passes to the fluid-conducting device (10) such that the primary fluid stream is able to penetrate into the primary conduits (14) in the conduit block (12), and such that a fluid flowing out of the fluid-conducting device (10) in the primary conduit direction is able to flow out of the fluid-conducting device (10) into the second tubing element.

2. The fluid-conducting device (10) as claimed in claim 1, wherein the multiple primary conduits (14) extend substantially parallel to one another, and/or wherein the at least one secondary conduit (16) is arranged so as to extend substantially in at least one secondary conduit plane, wherein the at least one secondary conduit plane preferably extends substantially perpendicular to the primary conduit direction (100).

3. The fluid-conducting device (10) as claimed in claim 1, wherein the fluid-conducting device (10) has multiple secondary conduits (16), and/or wherein the at least one secondary conduit (16) is formed at least partially within the conduit block (12).

4. The fluid-conducting device (10) as claimed in claim 1, wherein the at least one secondary conduit (16) is formed at least partially as a secondary conduit structure (18), and wherein the secondary conduit structure (18) is formed at least partially outside the conduit block (12) and is preferably fastened to the conduit block (12).

5. The fluid-conducting device (10) as claimed in claim 4, wherein the secondary conduit structure (18) is formed integrally with the conduit block (12) and/or is preferably produced at least partially by an additive manufacturing process.

6. The fluid-conducting device (10) as claimed in claim 1, wherein the multiple primary conduits (14) each have an inlet opening, wherein the inlet openings of the multiple primary conduits (14) are arranged so as to lie in an inlet plane, and wherein the conduit block (12) preferably terminates flush with the inlet openings.

7. The fluid-conducting device (10) as claimed in claim 1, wherein the fluid-conducting device (10) is formed integrally.

8. The fluid-conducting device (10) as claimed in claim 1, wherein the at least one secondary conduit (16) opens into a plurality of primary conduits (14) of the multiple primary conduits (14).

9. A tube plate for a heat exchanger, wherein the tube plate has a fluid-conducting device (10) as claimed in claim 1, and wherein the tube plate is designed such that tubings (24) are connectable to the primary conduits (14).

10. A tube reactor having a fluid-conducting device (10) as claimed in claim 1, wherein at least one reactor tube is connected to the primary conduits (14) so as to extend in the primary conduit direction (100).

11. A static mixer (26) having a fluid-conducting device (10) as claimed in claim 1, wherein at least one tubing element (28) is connected to the primary conduits (14) so as to extend in the primary conduit direction (100).

12. A method for mixing a secondary fluid into a primary fluid, comprising the steps of:
providing a fluid-conducting device (10) produced at least partially by an additive manufacturing process and having:
a conduit block (12), within which there are formed multiple primary conduits (14) which extend in a primary conduit direction (100) and which are designed to conduct a primary fluid;
at least one secondary conduit (16), which extends at least partially in a secondary conduit direction (102) extending at least partially perpendicular to the primary conduit direction (100) and which is designed to conduct a secondary fluid;
wherein the at least one secondary conduit (16) opens into at least one of the primary conduits (14) in order to allow the secondary fluid to flow into the at least one primary conduit (14) via the secondary conduit (16); and
wherein the multiple primary conduits (14) extend parallel to one another exclusively in a primary conduit direction, wherein the fluid-conducting device (10) is configured such that it can be arranged between two tubing elements and can be fastened thereto such that a primary fluid stream through the first tubing element in the primary conduit direction passes to the fluid-conducting device (10) such that the primary fluid stream is able to penetrate into the primary conduits (14) in the conduit block (12), and such that a fluid flowing out of the fluid-conducting device (10) in the primary conduit direction is able to flow out of the fluid-conducting device (10) into the second tubing element;
feeding the primary fluid into the primary conduits (14) such that the primary fluid flows through the primary conduits (14);
feeding the secondary fluid into the primary conduits (14) via the at least one secondary conduit (16) such that mixing of the secondary fluid with the primary fluid is realized in the primary conduits (14).

13. The method for mixing as claimed in claim 12, wherein the fluid-conducting device (10) has multiple secondary conduits (16), and wherein the feeding-in of the secondary fluid is realized via one or more secondary conduits (16) of the multiple secondary conduits (16) independently of the other secondary conduits (16) of the multiple secondary conduits (16).

14. A method for producing a fluid-conducting device (10) as claimed in claim 1, comprising producing the fluid-conducting device (10) at least partially by an additive manufacturing process.

15. A method for producing a tube plate as claimed in claim 9 for a heat exchanger, comprising producing the tube plate at least partially by an additive manufacturing process.
